(19) United States
(12) Patent Application Publication
(10) Pub. No.: US 2016/0371990 A1
(43) Pub. Date: Dec. 22, 2016

(54) HELIDECK SURVEILLANCE TRANSCEIVER

(71) Applicants: Charles Manberg, Peoria, AZ (US); Arnold Oldach, Carefree, AZ (US)

(72) Inventors: Charles Manberg, Peoria, AZ (US); Arnold Oldach, Carefree, AZ (US)

(73) Assignee: Aviation Communications & Surveillance Systems LLC, Phoenix, AZ (US)

(21) Appl. No.: 15/184,946

(22) Filed: Jun. 16, 2016

Related U.S. Application Data
(63) Continuation-in-part of application No. 14/814,284, filed on Jul. 30, 2015.
(60) Provisional application No. 62/180,464, filed on Jun. 16, 2015.
(60) Provisional application No. 62/180,448, filed on Jun. 16, 2015.

(51) Int. Cl. G08G 5/02; H04B 1/38; G08G 5/00; H04B 7/185; B64F 1/00; H04L 29/08; H04B 7/02

(52) U.S. Cl. CPC G08G 5/025; H04L 67/125; H04B 1/38; H04B 7/028; H04L 67/1097; H04B 7/18506; B64F 1/007; G08G 5/0091

(57) ABSTRACT

Various aviation systems may benefit from appropriately configured systems and methods for communication. For example, aircraft situational awareness systems and helideck systems may benefit from helideck surveillance transceiver systems and methods. An apparatus can include a transceiver and at least one data link antenna operably connected to the transceiver. The transceiver and the at least one data link antenna can be configured to obtain and distribute helideck information regarding a helideck to at least one helicopter.

### CROSS-REFERENCE TO RELATED APPLICATION

This application is related as a non-provisional to and claims the benefit and priority of U.S. Provisional Patent Application No. 62/180,464, “Systems and Methods for Providing a Helideck Surveillance Transceiver,” filed Jun. 16, 2015, the entirety of which is hereby incorporated herein by reference. This application is also related as a continuation-in-part to and claims the benefit and priority of U.S. patent application Ser. No. 14/814,284, filed Jul. 30, 2015, the entirety of which is hereby incorporated herein by reference. This application is also related to and claims priority from: (1) U.S. application Ser. No. 62/030,957, filed Jul. 30, 2014 and entitled “HELICOPTER PAD APPROACH SYSTEMS AND METHODS”; (2) U.S. application Ser. No. 62/030,980, filed Jul. 30, 2014 and entitled “PRECISION FINAL APPROACH LANDING SYSTEMS AND METHODS”; (3) U.S. application Ser. No. 62/031,000, filed Jul. 30, 2014 and entitled “HELICOPTER BUILDING SITUATIONAL AWARENESS SYSTEMS AND METHODS”; and (4) U.S. application Ser. No. 62/180,448, filed Jun. 16, 2015 and entitled “SYSTEMS AND METHODS FOR COCKPIT DISPLAY OF HELIDECK INFORMATION.” Each of applications (1), (2), (3), and (4) is hereby incorporated by reference in its entirety.

### BACKGROUND

Field:

Various aviation systems may benefit from appropriately configured systems and methods for communication. For example, aircraft situational awareness systems and helideck systems may benefit from helideck surveillance transceiver systems and methods.

Description of the Related Art:

Today's helicopter land-based/off-shore landing and departure operations during adverse conditions, such as low visibility and darkness, glare, rough seas, and the like may become a difficult task. During approach and take-off, flight crews may require helideck local weather and motion (for moving platforms) conditions to aid in flying in these adverse conditions. The combination of wind and motion experienced on helidecks is potentially hazardous in extreme conditions, as pilots may need to navigate close to installations affected by wind turbulence or experience a greater risk of the helicopter being tipped over.

Traditionally dealing with these adverse conditions has been dealt with primarily by relying on pilot skill and vocal or visual signals from ground crews, towers, or the like. This can limit the adverse conditions in which less experienced pilots can fly, and can pose a danger even to experienced pilots.

### SUMMARY

According to certain embodiments, an apparatus can include a transceiver and at least one data link antenna operably connected to the transceiver. The transceiver and the at least one data link antenna can be configured to obtain and distribute helideck information regarding a helideck to at least one helicopter.

In certain embodiments, a method can include obtaining helideck information regarding a helideck. The method can also include distributing, using a transceiver and at least one data link antenna operably connected to the transceiver, the helideck information to at least one helicopter.

### BRIEF DESCRIPTION OF THE DRAWINGS

For proper understanding of the invention, reference should be made to the accompanying drawings, wherein:

FIG. 1 illustrates a helideck surveillance transceiver according to certain embodiments.

FIG. 2 illustrates methods or functions according to certain embodiments.

FIG. 3 illustrates an aircraft transceiver according to certain embodiments.

### DETAILED DESCRIPTION

To support safer flight operations and improved reliability of operations as well as for other reason, helideck monitoring systems according to certain embodiments may have a number of features. These helideck monitoring systems may be located on or near the helideck and may provide real-time or near-real-time helideck wind and motion information. The real-time helideck wind and motion information may be communicated to the flight crew via voice, video, text, or other media. The information may be communicated sporadically, at defined intervals, or at defined intervals modified by some further contingency, such as whether other information is being presented.

Certain embodiments can provide the information digitally or in analog form over a data communication link. Providing this information over a data communications link to the flight deck may allow the helideck condition information to be continuously and reliably available to the flight crew during these challenging landing and departure operations. Also, additional helideck information, such as helideck identification, position, height, dimensions, and other information can be transmitted over the data communications link to provide additional helideck situational awareness to the flight crew.

Embodiments of the present invention may utilize a data link. For example, certain embodiments may use any point-to-point or broadcast medium including but not limited to 1090 MHZ/1090 MHz Phase Enhancement, cellular, Wifi/WiMAX/AeroMACS, VDL Mode 2, VDL Mode 4, or 978 MHz UAT, or the like. The data link may be used to provide real-time surveillance of the helideck environmental conditions. The helideck environmental conditions can include, for example, gas plumes, high temperature exhaust plumes, gas burn off, release of process gas, wind flow around the platform, turbulence and other environmental conditions caused by other than meteorological conditions. The real-time surveillance can also include meteorological and motion conditions. The data link can provide the real-time surveillance for the on-board aircraft systems to receive, process and display the information on flight deck displays in real-time.

Phase Enhancement, sometimes alternatively referred to as “ATC-Data Overlay” or Phase Modulation, is a term referencing ACSS technology variously described in the following patent applications and patents, hereby incorporated herein by reference: application Ser. No. 60/926,126, filed Apr. 24, 2007; application Ser. No. 12/105,248, filed Apr. 17, 2008; application Ser. No. 60/931,274, filed May 21, 2007; application Ser. No. 61/054,029, filed May 16, 2008; application Ser. No. 61/059,736, filed Jun. 6, 2008; application Ser. No. 61/060,385, filed Jun. 10, 2008; application Ser. No. 61/163,747, filed Mar. 26, 2009; application Ser. No. 61/176,046, filed May 6, 2009; application Ser. No. 12/467,997, filed May 18, 2009 (now U.S. Pat. No. 8,344,936); application Ser. No. 12/482,431, filed Jun. 10, 2009 (now U.S. Pat. No. 8,031,105); application Ser. No. 12/455,886, filed Jun. 8, 2009; application Ser. No. 61/253,981, filed Oct. 22, 2009; application Ser. No. 12/748,351, filed Mar. 26, 2010; application Ser. No. 12/775,321, filed May 6, 2010; application Ser. No. 12/910,642, filed Oct. 22, 2010; application Ser. No. 61/845,864, filed Jul. 12, 2013 and application Ser. No. 14/331,089, filed Jul. 14, 2014.

Embodiments of the present invention may be installed on or near a helideck and interfaced to helideck systems that may provide the weather, environmental, and motion conditions, as well as other helideck information (e.g., helideck GPS positional coordinates, helideck identification, helideck elevation, helideck dimensions, etc.). The helideck information may be received from an external system, received from a helideck system, previously stored or configured, measured by a sensor or similar equipment, or manually entered. The helideck information may be transmitted at defined intervals over the data link for helideck position, elevation, and velocity (moving vessels) information and other helideck information, such as current weather, motion, elevation, dimensions, NOTAMS, etc.

Embodiments of the present invention can be used on fixed helidecks. Examples of fixed helidecks include those helidecks installed in the following environments: offshore, hospitals, corporate, buildings, airports, and the like. Embodiments of the present invention can also be used on moving helidecks. Examples of moving helidecks include those helidecks installed in the following environments: ships, drilling ships, yachts, barges, and the like. Embodiments of the present invention can also be used in connection with search and rescue base operation locations and emergency base operations. Thus, for example, a helideck system can be provided in a host structure that includes a hospital, a battleship, a yacht, an ocean liner, an offshore platform, an office building, a hotel, an airport, a train, an aircraft carrier, a ship, a search and rescue operation, or any other suitable structure.

Certain embodiments can broadcast, multicast, unicast or otherwise transmit various categories of helideck information via the data link. For example, certain embodiments can transmit helideck characteristics, such as platform name/station identification, helideck GPS position coordinates, center of helideck, elevation/altitude, heading/velocity (moving helidecks), helideck dimension, and the like. Furthermore, for example, certain embodiments can transmit helideck dynamic motion information such as pitch, roll, heave, motion severity index, wind severity index, wind/gust/motion trend information, and the like.

Likewise, certain embodiments can transmit local current time stamped weather conditions, such as reporting station identification, current time, wind direction and speed, gust speed, temperature, cloud height, icing conditions, typical METAR content, or the like. This information may be received from an external system, received from a helideck system, previously stored or configured, measured by a sensor or similar equipment, or manually entered. Additionally, for example, certain embodiments can transmit manually entered current conditions of interest to flight crews similar to ATIS/NOTAMS, or the like.

Moreover, certain embodiments can transmit trend information such as gust trends, ceiling/visibility trends, motion indices, or the like. Additionally, certain embodiments can transmit data link capability to communicate the helideck parameters. For example, the transceiver may communicate the categories of information available, or protocols that can be used to communicate over the data link. The transceiver may, for example, identify a version or build number of other indicator that briefly identifies the communication capabilities of the transceiver. Alternatively, the transceiver may provide a menu of capabilities.

Embodiments of the present invention for a helideck surveillance transceiver may provide the capability to receive data from the data link to provide communications from an approaching helicopter. The received data can be used to configure the transceiver supply information to the helideck operators, or process parameters from surrounding aircraft, such as current sensed weather conditions associated with the aircraft current position.

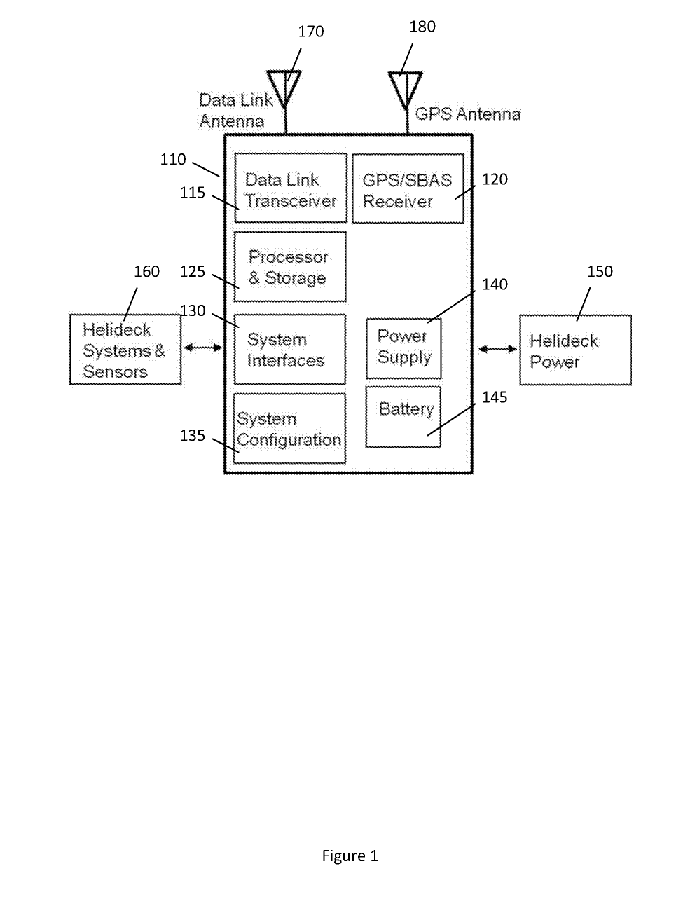

FIG. 1 illustrates a helideck surveillance transceiver according to certain embodiments. The components shown in FIG. 1 and discussed below are simply non-exhaustive examples of components that can be included.

For example, as shown in FIG. 1, a transceiver 110 can include a data link transceiver 115 to broadcast or otherwise transmit and receive data. The data link transceiver 115 can be configured to communicate according to any desired communication protocol set.

The transceiver 110 can also include an embedded global positioning system (GPS)/space-based augmentation system (SBAS) 120, providing helideck position, elevation, local current time, or the like.

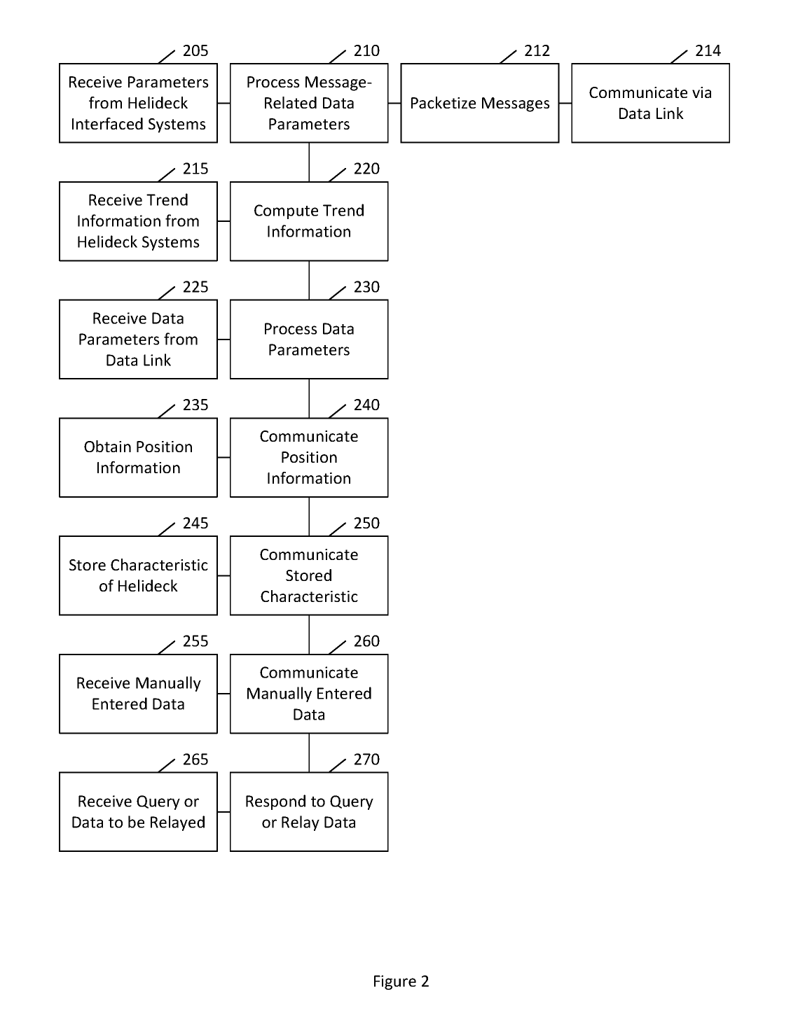

The transceiver 110 can further include at least one processor and memory 125 that may perform several functions. These functions are described in more detail in FIG. 2

The transceiver 110 can also include system interfaces 130 to helideck systems and sensors 160, including, for example, weather reporting systems, motion detection systems and other systems, as desired. Furthermore, the transceiver 110 can include system configuration 135. This configuration capability may allow installers to program helideck information, such as a helideck identifier, helideck landing center coordinates, helideck dimensions, and the like.

The transceiver 110 can include a power supply 140. The power supply 140 can include a connection to a power grid or to some local generation source, such as a solar panel. The transceiver 110 can also include a battery 145 to provide backup during power loss or to supply direct current (DC) in other contexts. Optionally, the power supply 140 can be connected to helideck power 150, which may provide power from an electrical grid or other source.

The transceiver 110 can have a plurality of antennas. For example, the transceiver 110 can include a data link antenna 170 and a GPS antenna 180.

As mentioned above, FIG. 2 illustrates methods or functions according to certain embodiments. As shown in FIG. 2, a method can include, at 210, processing data parameters received from helideck interfaced systems at 205 and, at 212, packetizing the messages into a form to be broadcast or otherwise communicated at 214 via the data link. The method can also include, at 220, computing trend information received at 215 from helideck systems for broadcast via the data link. The method can further include, at 230, processing data parameters such as metrological data from aircraft, aircraft performance and health monitoring data (for example, ACMS, HUMS, HEMS, and the like) and aircraft location and other relevant parameters (in case of aircraft emergencies) received from the data link at 225.

The method can also include, at 240, communicating position information to the at least one helicopter. This can be information obtained at 235 from a position sensor, such as a GPS sensor. The position information can be accompanied by other information such as velocity, vector, heading, altitude, and the like.

The method can further include, at 250, communicating a characteristic of the helideck to the at least one helicopter. This may be a characteristic that was previously stored at 245.

The method can further include, at 260, communicating manually entered data to the at least one helicopter. This may be manually entered data that was previously received at 255, for example, from a user interface of the transceiver or a user interface of one of the other helideck systems.

The method can further include, at 265, receiving queries or data to be relayed from the at least one helicopter. The method can also include, at 270, responding to the queries or relaying the data to a further external system.

Thus, in certain embodiments an apparatus can include a transceiver, such as transceiver 110 in FIG. 1, and at least one data link antenna, such as data link antenna 170, operably connected to the transceiver. The connection may be a direct connection or the data link antenna(s) may be indirectly connected to the transceiver, for example via a relay, a waveguide, or cabling.

The transceiver and the at least one data link antenna can be configured to obtain and distribute helideck information to at least one helicopter. Here the term helicopter can broadly refer to aircraft other than traditional fixed wing aircraft, such as any aircraft configured to perform vertical take-off and landing on a helideck. The term helicopter can also broadly include unmanned aerial vehicles including, for example, quadracopters, drones, and the like.

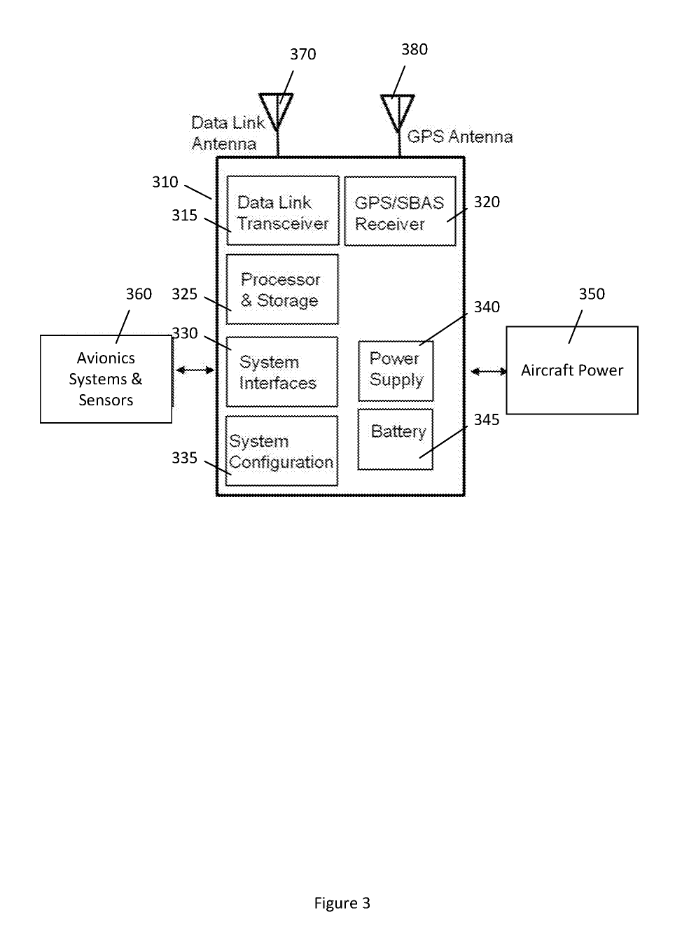

FIG. 3 illustrates an aircraft transceiver according to certain embodiments. The components shown in FIG. 3 and discussed below are simply non-exhaustive examples of components that can be included.

For example, as shown in FIG. 3, a transceiver 310 can include a data link transceiver 315 to broadcast or otherwise transmit and receive data. The data link transceiver 315 can be configured to communicate according to any desired communication protocol set.

The transceiver 310 can also include an embedded global positioning system (GPS)/space-based augmentation system (SBAS) 320, providing aircraft position, altitude, velocity, local current time, or the like.

The transceiver 310 can further include at least one processor and memory 325 that may perform several functions. These can be reciprocal functions to those illustrated in FIG. 2. For example, the transceiver 310 can be configured to send the communications that are received by the transceiver 110 in FIG. 1 and to receive the communications that are sent by the transceiver 110 in FIG. 1, for example over a data link between the two transceivers.

The transceiver 310 can also include system interfaces 330 to avionics systems and sensors 360, including, for example, weather reporting systems, situational awareness display systems and other systems, as desired. Furthermore, the transceiver 310 can include system configuration 335. This configuration capability may allow installers to program avionics information, such as an aircraft identifier, aircraft dimensions, and the like.

The transceiver 310 can include a power supply 340 and battery 345. The power supply 340 can be connected to aircraft power 350, which may provide power generated by a hosting aircraft.

The transceiver 310 can have a plurality of antennas. For example, the transceiver 310 can include a data link antenna 370 and a GPS antenna 380.

One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention.

We claim:

1. An apparatus, comprising:
a transceiver; and
at least one data link antenna operably connected to the transceiver,
wherein the transceiver and the at least one data link antenna are configured to obtain and distribute helideck information regarding a helideck to at least one helicopter.

2. The apparatus of claim 1, further comprising:
an interface configured to obtain the helideck information from at least one of a helideck system or a helideck sensor.

3. The apparatus of claim 1, further comprising:
at least one processor; and
at least one memory including computer program code,
wherein the at least one processor and the computer program code are configured to, with the at least one processor, cause the apparatus at least to process the helideck information; and
prepare messages to be transmitted to the at least one helicopter based on the processed helideck information.

4. The apparatus of claim 3, wherein the helideck information comprises parameters from helideck interfaced systems, and wherein the at least one processor and the computer program code are further configured to, with the at least one processor, cause the apparatus at least to extract information from the parameters for inclusion in the messages.

5. The apparatus of claim 3, wherein the at least one processor and the computer program code are further configured to, with the at least one processor, cause the apparatus at least to compute trend information from information received from at least one helideck system for inclusion in the messages.

6. The apparatus of claim 3, wherein the at least one processor and the computer program code are further configured to, with the at least one processor, cause the apparatus at least to extract information from data parameters received from the at least one helicopter.

7. The apparatus of claim 6, wherein the data parameters comprise at least one of metrological data from aircraft, aircraft performance data, health monitoring data, or aircraft location.

8. The apparatus of claim 6, wherein the data parameters are communicated over a data link to a system remote from the helideck or stored.

9. The apparatus of claim 1, wherein the transceiver and the at least one data link antenna are configured to distribute the helideck information using phase enhancement.

10. The apparatus of claim 1, further comprising:
a position sensor configured to provide at least position information, wherein the transceiver is configured to communicate the position information to the at least one helicopter.

11. The apparatus of claim 1, wherein the transceiver is further configured to transmit to the at least one helicopter at least one stored characteristic of the helideck.

12. The apparatus of claim 1, wherein the transceiver is further configured to receive manually entered data and transmit the manually entered data to the at least one helicopter.

13. The apparatus of claim 1, wherein the transceiver is configured to receive queries from the at least one helicopter and to respond to the queries.

14. The apparatus of claim 1, wherein the transceiver is configured to relay information from the at least one helicopter to at least one external system.

15. A method, comprising:
obtaining helideck information regarding a helideck; and
distributing, using a transceiver and at least one data link antenna operably connected to the transceiver, the helideck information to at least one helicopter.

16. The method of claim 15, wherein the obtaining the helideck information comprises receiving the helideck information over an interface from at least one of a helideck system or a helideck sensor.

17. The method of claim 15, further comprising:
processing the helideck information; and
preparing messages to be transmitted to the at least one helicopter based on the processed helideck information.

18. The method of claim 17, wherein the helideck information comprises parameters from helideck interfaced systems, the method further comprising:
extracting information from the parameters for inclusion in the messages.

19. The method of claim 17, further comprising:
computing trend information from information received from at least one helideck system for inclusion in the messages.

20. The method of claim 17, further comprising:
extracting information from data parameters received from the at least one helicopter.

21. The method of claim 20, wherein the data parameters comprise at least one of metrological data from aircraft, aircraft performance data, health monitoring data, or aircraft location.

22. The method of claim 20, further comprising:
storing the data parameters or communicating the data parameters over a data link to a system remote from the helideck.

23. The method of claim 15, wherein the distributing the helideck information comprises transmitting the helideck information using phase enhancement.

24. The method of claim 15, further comprising:
obtaining at least position information from a position sensor; and
communicating the position information to the at least one helicopter.

25. The method of claim 15, further comprising:
transmitting to the at least one helicopter at least one stored characteristic of the helideck.

26. The method of claim 15, further comprising:
receiving manually entered data; and
transmitting the manually entered data to the at least one helicopter.

27. The method of claim 15, further comprising:
receiving queries from the at least one helicopter; and
responding to the queries.

28. The method of claim 15, further comprising:
relaying information from the at least one helicopter to at least one external system.

29. A system, comprising:
a host structure configured to provide a helideck; and
a helideck system comprising a transceiver and at least one data link antenna operably connected to the transceiver,
wherein the transceiver and the at least one data link antenna are configured to obtain and distribute helideck information regarding the helideck to at least one helicopter.

30. The system of claim 29, wherein the host structure comprises at least one of a hospital, a battleship, a yacht, an ocean liner, an offshore platform, an office building, a hotel, an airport, a train, an aircraft carrier, a ship, or search and rescue operation.

31. An apparatus, comprising:
a transceiver; and
at least one data link antenna operably connected to the transceiver,
wherein the transceiver and the at least one data link antenna are configured to communicate with a helideck regarding helideck information from at least one helicopter.
